(19) United States
(12) Patent Application Publication
(10) Pub. No.: US 2024/0427985 A1
(43) Pub. Date: Dec. 26, 2024

(54) METHOD AND SYSTEM FOR CONVERTING LEGAL DOCUMENTS INTO STRUCTURED DATA USING AI

(71) Applicant: FORMALLY, INC., Redwood City, CA (US)

(72) Inventors: Amelie-Sophie Vavrovsky, Stanford, CA (US); Justin Poliachik, Wilmington, NC (US)

(73) Assignee: FORMALLY, INC., Redwood City, CA (US)

(21) Appl. No.: 18/754,033

(22) Filed: Jun. 25, 2024

Related U.S. Application Data
(60) Provisional application No. 63/510,140, filed on Jun. 25, 2023.

(51) Int. Cl. G06F 40/186; G06F 40/40; G06Q 50/18; G06V 30/19; G06V 30/22; G06V 30/42

(52) U.S. Cl. CPC G06F 40/186; G06F 40/40; G06Q 50/18; G06V 30/19; G06V 30/22; G06V 30/42

(57) ABSTRACT

In an embodiment, a method for converting a set of legal documents of varied type related to a legal task into structured data suitable for the legal task is disclosed. The method uses artificial intelligence and is performed by at least one processor including hardware. The method includes receiving digitized versions of a plurality of legal documents from a user. The method further includes extracting electronic data from the digitized legal documents using optical character recognition and analyzing the extracted electronic data from each document using a sequence of microprompts to a trained large language model. The analyzing includes using the LLM to identify a type of the document and data keys within the electronic data, and to generate a name for the document. The method further includes storing and sending to the user the analyzed electronic data processed with the LLM as structured data suitable for the legal task.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### CROSS REFERENCE TO RELATED APPLICATION

This application claims the priority of U.S. Provisional Application No. 63/510,140, entitled “OCR and LLMs for Immigration and Legal Data,” filed on Jun. 25, 2023, the disclosure of which is hereby incorporated by reference in its entirety.

### BACKGROUND

This application relates to the field of Artificial Intelligence (“AI”) and data processing, and in particular, the application of Optical Character Recognition (“OCR”) and AI for converting a set of legal documents of varied type related to a legal task into structured data suitable for the legal task.

Legal processes often require supporting documents which are on paper or in another physical format, such as driver's licenses, certified birth and death certificates, passports, work papers, awards, contracts, court rulings, patient records, lab reports, invoices, receipts, financial statements, and other various documents. Current OCR systems are capable of transforming printed text into machine-encoded text but lack the ability to understand and contextualize the content of the text. Therefore, while people can currently scan in these documents as image or PDF files, current technology still requires people to read and process the data themselves. Manual data entry and processing practices can be slow and may lead to human errors, which can adversely affect the legal process due to delays and mistakes.

As such, a system is needed that can more intelligently take a set of various legal documents and not only digitize them but intelligently extract and analyze the relevance of the data in the documents and present the relevant data in a structured set that can then be used for a legal task, e.g., the preparation and submission of an O1 VISA application. Such a system would significantly reduce the dependency on human resources for data entry tasks, thereby drastically minimizing potential errors and improving efficiency and processing speed. It would also allow human resources to be reallocated to more strategic and cognitive tasks, thereby enhancing overall productivity.

### SUMMARY

In an embodiment, a method for converting a set of legal documents of varied type related to a legal task into structured data suitable for the legal task using artificial intelligence is disclosed. The method is performed by at least one processor comprising hardware. The method comprises receiving digitized versions of a plurality of legal documents from a user and extracting electronic data from the digitized legal documents using OCR. The method further comprises analyzing the extracted electronic data from each document using a sequence of microprompts to a trained Large Language Model (“LLM”). The analyzing comprises using the LLM to identify a type of the document from which the electronic data was extracted; using the LLM to identify data keys within the electronic data based on the identified document type and a set of curated data key templates for such document type, and to assign portions of the electronic data to the data keys identified for each such portion; and using the LLM to generate a name for the document. The method further comprises storing and sending to the user the analyzed electronic data processed with the LLM as structured data suitable for the legal task.

In an embodiment, the legal documents include one or more documents with handwritten text, and the step of extracting data using OCR comprises calibrating the OCR to recognize handwritten text. The legal documents may include one or more documents with diverse font styles and sizes, and the step of extracting data using OCR may comprise using an OCR calibrated to recognize font of diverse styles and sizes. The legal documents may relate to immigration, and using the OCR may comprise using OCR calibrated to recognize font of diverse styles and sizes typically used in immigration documents.

In an embodiment, the legal documents relate to immigration, and analyzing the extracted data using the LLM comprises using an LLM which has been trained on immigration terminologies and document formats. In an embodiment, the LLM has been trained on evidence required in immigration cases to thereby identify document types and data keys based on an identification of such evidence in the extracted electronic data. In an embodiment, the user may be allowed to modify the sequence of LLM microprompts. The extracted electronic data may be analyzed by a plurality of LLMs, and the extracted data may be sent to the plurality of LLMs in parallel. The method may further comprise ranking the structured data produced by the plurality of LLMs based on a ranking system and identifying a top ranked set of structured data to send to the user.

In an embodiment, a system for converting a set of legal documents of varied type related to a legal task into structured data suitable for the legal task using artificial intelligence is disclosed. The system comprises a web application configured to receive digitized versions of a plurality of legal documents from a user. The system further comprises a database for storing the received digitized legal documents, and a task function queue for coordinating the processing of the digitized legal documents into structured data.

The task function queue is configured to transmit the digitized legal documents to an OCR system to extract electronic data from the digitized legal documents. The task function queue is further configured to transmit the extracted electronic data from each document to a trained LLM using a sequence of microprompts to analyze the extracted electronic data to (i) identify a type of the document from which the electronic data was extracted, (ii) identify data keys within the electronic data based on the identified document type and a set of curated data key templates for such document type, (iii) assign portions of the electronic data to the data keys identified for each such portion and (iv) generate a name for the document. The task function queue is further configured to receive, store and send to the user the analyzed electronic data processed with the LLM as the structured data suitable for the legal task.

In an embodiment, the legal documents include one or more documents with handwritten text, and the digitized legal documents are transmitted to an OCR system calibrated to recognize handwritten text. In an embodiment, the legal documents relate to immigration, and the digitized legal documents are transmitted to an OCR system calibrated to recognize font of diverse styles and sizes typically used in immigration documents.

In an embodiment, the legal documents relate to immigration and an LLM which has been trained on immigration terminologies and document formats is used. An LLM which has been trained on evidence required in immigration cases may be used to thereby identify document types and data keys based on an identification of such evidence in the extracted electronic data. In an embodiment, the task function queue allows the user to modify the sequence of LLM microprompts. The extracted electronic data may be transmitted to a plurality of LLMs in parallel. In an embodiment, the system is configured to rank the structured data produced by the plurality of LLMs based on a ranking system and identify a top ranked set of structured data to send to the user.

In an embodiment, non-transitory computer-readable media comprising program code that when executed by a programmable processor causes execution of a method using artificial intelligence for converting a set of legal documents of varied type related to a legal task into structured data suitable for the legal task is disclosed. The computer readable media comprises computer program code for receiving from a user digitized versions of a plurality of legal documents and extracting electronic data from the digitized legal documents using OCR. The computer readable media further comprises computer program code for analyzing the extracted electronic data from each document using a sequence of microprompts to a trained LLM. The analyzing comprises using the LLM to identify a type of the document from which the electronic data was extracted; using the LLM to identify data keys within the electronic data based on the identified document type and a set of curated data key templates for such document type, and to assign portions of the electronic data to the data keys identified for each such portion; and using the LLM to generate a name for the document. The computer readable media further comprises computer program code for storing and sending to the user the analyzed electronic data processed with the LLM as structured data suitable for the legal task.

The foregoing summary is illustrative only and is not intended to be in any way limiting. These and other illustrative embodiments include, without limitation, apparatus, systems, methods and computer-readable storage media. In addition to the illustrative aspects, embodiments, and features described above, further aspects, embodiments, and features will become apparent by reference to the drawings and the following detailed description.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 is a diagram of a system that extracts and cross-references legal data using AI according to an embodiment.

FIG. 2 is a flow diagram of an example process for extracting and cross-referencing legal data using AI according to an embodiment.

FIG. 3 is a flow diagram of an example process for extracting and cross-referencing legal data with an LLM ranking system according to an embodiment.

FIG. 4 is a flow diagram of an example process for ranking structured data produced by LLMs using microprompts according to an embodiment.

FIG. 5 is a diagram of a system comprising a prompt data package for extracting and cross-referencing legal data using AI according to an embodiment.

FIGS. 6-8 are a user interface according to an embodiment.

FIG. 9 is a user interface for configuring user-facing settings according to an embodiment.

FIG. 10 is a diagram of a system that allows a user to upload mail for extracting and cross-referencing legal data therein using AI according to an embodiment.

FIG. 11 is a flow diagram of an example process for uploading mail for extracting and cross-referencing legal data therein using AI according to an embodiment.

FIGS. 12-15 are a user interface according to an embodiment.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the illustrative embodiments. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

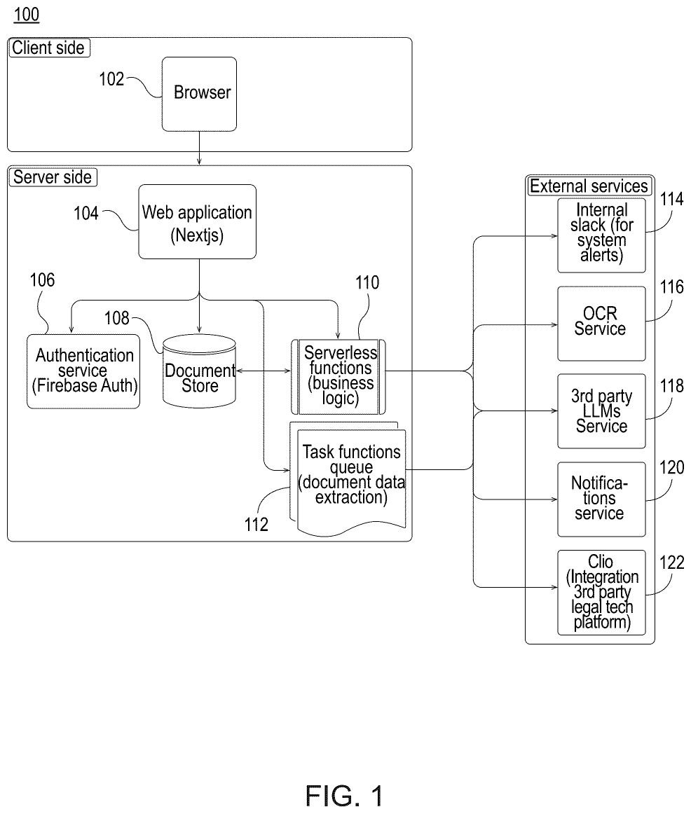

With reference to FIG. 1, a system 100 is disclosed in accordance with embodiments of the invention that extracts and cross-references legal data. System 100 comprises a web application 104 which utilizes OCR technology in conjunction with LLMs which have been trained with a focus on legal documents and terminologies in a given field, e.g., immigration law. In some embodiments, system 100 is tailored for immigration applications using editable criteria built into the LLM training process.

Web application 104 is accessible via browser 102. System 100 receives uploads of scanned documents from a user. Such documents may include a passport, birth certificate, driver's license, work papers, awards, and the like. An OCR Service 116 accurately scans and transforms text-based data from this multitude of legal documents into machine-encoded digital text. OCR Service 116 is calibrated to accurately recognize a wide array of diverse fonts and handwriting styles, which are often not standardized in immigration paperwork. OCR Service 116 recognizes the characters and words in physical or digital documents, essentially turning an image of text into actual text that can be manipulated and processed by a computer.

Once the physical text has been digitized, an LLMs Service 118 interprets, categorizes, and cross-references the OCR-generated data. LLMs are AI models that have been trained on extensive sets of data and are capable of understanding and generating human-like text from minimal textual cues. Based on a training set, the LLMs of LLMs Service 118 identify the type of document, e.g., passport, birth certificate, driver's license, etc., identify which of the scanned in text belongs to which type or field of data based on the system's curated document types, identify a name for the document, and return to the user a set of structured, properly extracted and formatted documents which the user can then use for some legal purpose, e.g., to apply for a VISA or citizenship.

In an embodiment, the LLMs of LLMs Service 118 have been specifically trained on legal documents and terminologies, for example, a training set comprising immigration documents, making them particularly effective at recognizing and understanding the intricate patterns and structures of legal texts. In an embodiment, system 100 identifies implied contexts, such as recognizing “co-pay” from mentions of “amount” alone, by leveraging the advanced natural language understanding capabilities of LLMs. This results in a more in-depth understanding and accurate identification of the type of document and its content.

System 100 further comprises server-side services including an Authentication Service 106, a Document Store 108, serverless functions 110, and a task functions queue 112 for document data extraction. System 100 further comprises external services including system alerts platform 114, notifications service 120, and integration with a third-party legal tech platform 122.

System 100 is an automated system that not only turns physical text into digital text, but also understands, categorizes, and cross-references that text. This significantly reduces the potential for human error, improves efficiency in immigration procedures, and allows human resources to be reallocated to more strategic and cognitive tasks, thereby enhancing overall productivity.

The automated conversion of physical document text to digital text embodied in system 100 has the potential to eliminate traditional, manual data entry practices. The automation of the extraction and interpretation process drastically minimizes potential errors while improving efficiency and enhancing workspace productivity. As such, system 100 represents a significant advancement in the field of legal data processing. It has the potential to revolutionize traditional ways of managing and processing legal data, making these processes more accurate and efficient.

Although system 100 is discussed for use in legal data processing specific to immigration law, it may be adapted for various applications. The capacity of system 100 to digitize, interpret, categorize, and cross-reference data from documents can be applied broadly to the legal industry in general. For example, system 100 enables automatic extraction and cross-referencing of legal data for contracts, court rulings, or legal briefs, thereby saving lawyers and legal staff substantial time while reducing the potential for errors.

In an embodiment, system 100 may be used in healthcare to process and understand patient records, lab reports, and clinical trial documents. System 100 could aid in organizing patient information, improving the accuracy of data interpretation, and automating administrative tasks, which would enhance patient care and healthcare research.

In an embodiment, system 100 may be used in finance and banking for automating the extraction and categorization of data from financial documents such as invoices, receipts, bank statements, or tax documents. This would enhance financial analysis, reduce errors in financial reporting, and streamline administrative tasks, leading to improved financial management.

Many government services require the processing of various forms and documents. In an embodiment, system 100 may be used to automate such processing, thus improving efficiency, reducing backlog, and enhancing public service delivery.

In an embodiment, system 100 may be used to process and categorize data from various educational documents such as student records, examination sheets, or research papers. This would help in administrative tasks, educational research, and personalized education planning.

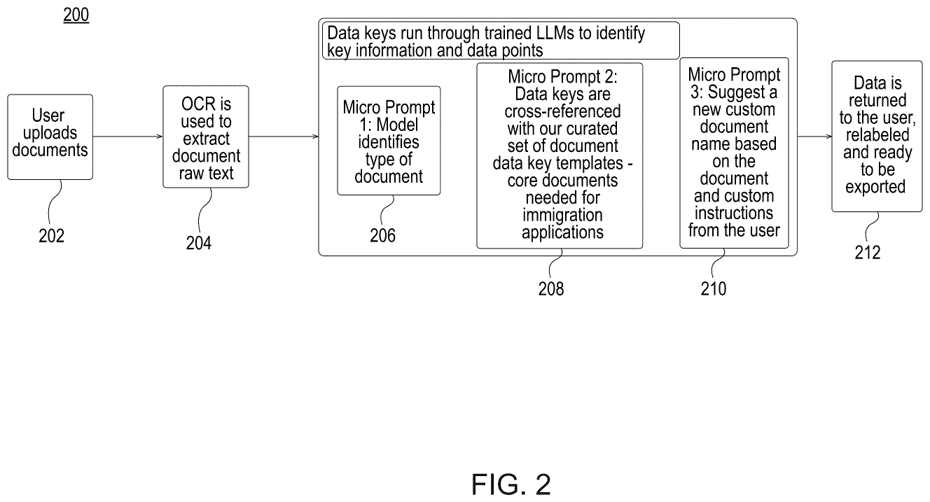

With reference to FIG. 2, a process 200 of using system 100 to extract and cross-reference legal data in accordance with some embodiments will now be described. The process of FIG. 2 comprises steps 202 through 212 and is suitable for use in system 100 but is more generally applicable to other types of systems for data processing using artificial intelligence.

At step 202, legal documents are introduced into system 100 via user upload. At step 204, physical text is scanned, recognized, and converted into digital format (i.e., electronic data) using OCR. For example, in the case of an immigration attorney preparing an O1 visa application, an applicant's portfolio is scanned and digitized.

At steps 206 through 210, data keys are run through trained LLMs to identify key information and data points in the electronic data. Digitized text is processed by LLMs guided by user-defined microprompts, which ensure targeted analysis and categorization. A microprompt engine allows for the dynamic creation and modification of prompts that direct the LLM's focus during document analysis-a feature uniquely designed for the variable nature of legal documents in immigration. For example, an attorney uses the microprompt engine to extract specific details that highlight the applicant's extraordinary abilities, thus streamlining the preparation of a compelling visa application. In some embodiments, microprompts may include prompts to identify a type of document, to cross-reference data keys with a curated set of document data key templates from core documents needed for immigration applications, or to suggest a new custom document name based on the document type and custom instructions from the user.

At step 212, a data categorization unit outputs structured data with appropriate categories and tags based on the comprehensive analysis. Using intelligence far beyond simple keyword matching, the data categorization unit automatically sorts and tags immigration documents into pertinent legal categories like visa applications, proof of extraordinary ability, awards, publications and other documents critical for immigration case files such as O1s and EB1s. For example, system 100 categorizes a minimally labeled document as an “award,” recognizing its significance based on contextual cues trained into the model.

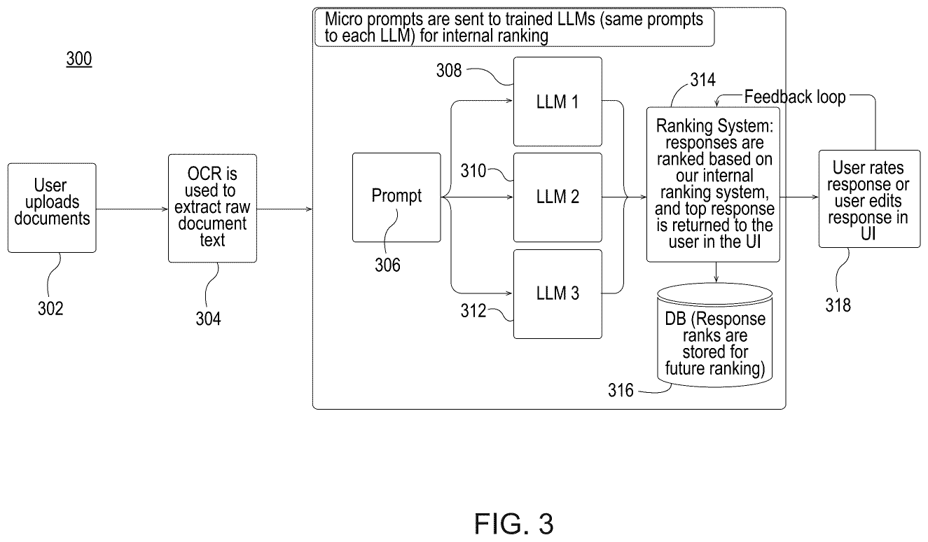

With reference to FIG. 3, a process 300 of using system 100 to extract and cross-reference legal data with an LLM ranking system in accordance with some embodiments will now be described. The process of FIG. 3 comprises steps 302 through 318 and is suitable for use in system 100 but is more generally applicable to other types of systems for data processing using artificial intelligence.

At step 302, legal documents are introduced into system 100 via user upload. At step 304, physical text is scanned, recognized, and converted into digital format (i.e., electronic data) using OCR. At step 306, microprompts are sent to trained LLMs 308, 310, and 312. The user may input a specific microprompt to direct the LLMs' analysis. This enables customized data extraction and precise document labeling.

In an embodiment, the same prompts are sent to each LLM 308, 310, and 312. At step 314, responses from LLMs 308, 310, and 312 are ranked based on an internal ranking system. The top response is returned to the user in the user interface. At step 316, response ranks are stored in a database for future ranking. At step 318, the user rates or edits the response in the user interface. Process 300 comprises a feedback loop between steps 314, 316, and 318.

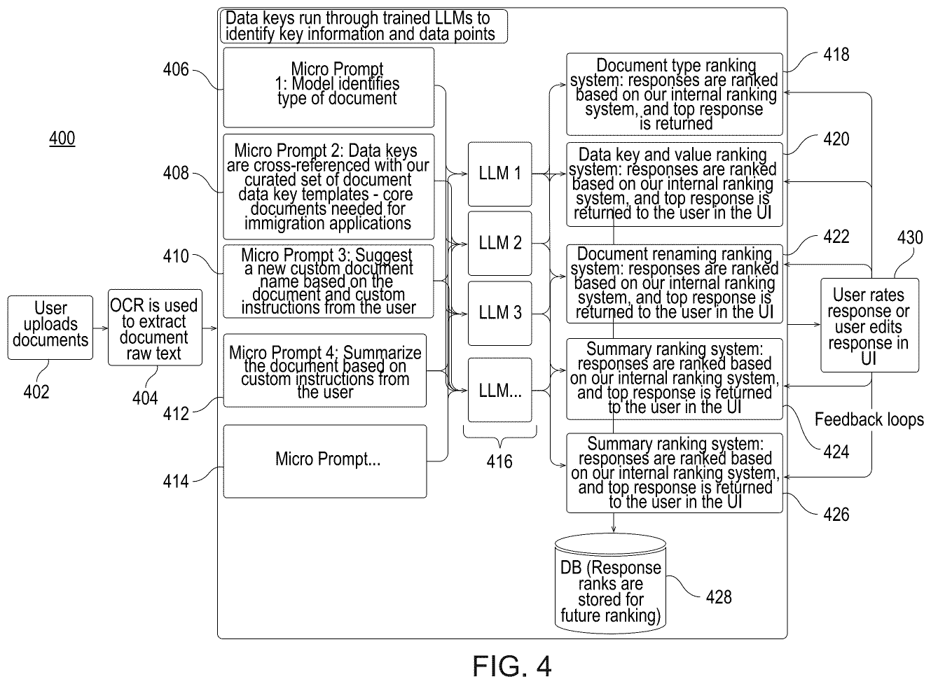

With reference to FIG. 4, a process 400 of using system 100 to rank structured data produced by LLMs using microprompts in accordance with some embodiments will now be described. The process of FIG. 4 comprises steps 402 through 430 and is suitable for use in system 100 but is more generally applicable to other types of systems for data processing using artificial intelligence.

At step 402, legal documents are introduced into system 100 via user upload. At step 404, physical text is scanned, recognized, and converted into digital format (i.e., electronic data) using OCR. At steps 406 through 414, data keys are run through trained LLMs 416 to identify key information and data points within the electronic data based on the identified document type and a set of curated data key templates for such document type. LLMs 416 assign portions of the electronic data to the data keys identified for each such portion.

In an embodiment, the microprompt at step 406 comprises identifying the type of document. In an embodiment, the microprompt at step 408 comprises cross-referencing data keys with a curated set of document data key templates, which are core documents needed for immigration applications. In an embodiment, the microprompt at step 410 comprises suggesting a new custom document name based on the document type and custom instructions from the user. In an embodiment, the microprompt at step 412 comprises summarizing the document based on custom instructions from the user. Additional microprompts may be utilized at step 414.

At steps 418 through 426, output responses of LLMs 416 are processed through various ranking systems. At step 418, a document type ranking system ranks responses based on an internal ranking system, wherein the top response is returned to the user in the user interface. Other ranking systems may comprise a data key and value ranking system (420), a document renaming ranking system (422), and a summary ranking system (424, 426).

At step 428, response ranks are stored in a database for future ranking. At step 430, the user rates or edits the response in the user interface. Process 400 comprises a feedback loop between steps 418-426, 428, and 430.

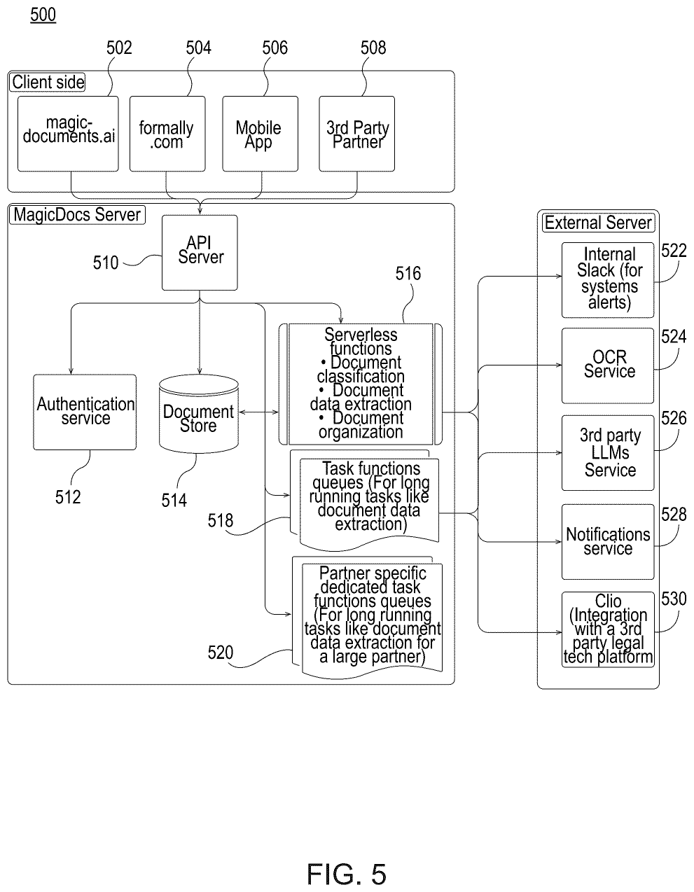

With reference to FIG. 5, a system 500 is disclosed in accordance with embodiments of the invention that comprises a comprehensive prompt data package for extracting and cross-referencing legal data. System 500 comprises an Application Programming Interface (“API”) server 510 which utilizes OCR technology in conjunction with LLMs which have been trained with a focus on legal documents and terminologies in a given field, e.g., immigration law. In some embodiments, system 500 is tailored for immigration applications using editable criteria built into the LLM training process.

API server 510 may be accessible via URLs 502 and 504, mobile app 506, and third-party partner 508 upon client-side service sending an API request to the server to process. System 500 receives uploads of scanned documents from a user. Such documents may include a passport, birth certificate, driver's license, work papers, awards, and the like. The request and documents are stored in a document store 514. In an embodiment, the request is initiated directly by serverless functions 516. Serverless functions 516 comprise document classification, document data extraction, and document organization. In another embodiment, the request is enqueued to the proper task function queue.

An OCR Service 524 accurately scans the documents and extracts machine-encoded digital text from text-based data. OCR Service 524 is calibrated to accurately recognize a wide array of diverse fonts and handwriting styles, which are often not standardized in immigration paperwork. OCR Service 524 recognizes the characters and words in physical or digital documents, essentially turning an image of text into actual text that can be manipulated and processed by a computer.

Once the physical text has been digitized, a first microprompt is sent to an LLMs Service 526 to classify the type of document, e.g., passport, birth certificate, driver's license, etc. Based on the response from the first microprompt, a curated template of expected data for the given document type is selected. In an embodiment, a user-provided template of expected data may be used.

A second microprompt is sent to LLMs Service 526 to classify as much of the data from the raw document text as possible based on the expected data for the given document type. In an embodiment, additional microprompts may be sent to LLMs Service 526 to get additional document metadata and format or otherwise organize the document by, for example, renaming the document or creating a document summary. In an embodiment, the LLMs of LLMs Service 526 have been specifically trained on legal documents and terminologies, for example, a training set comprising immigration documents, making them particularly effective at recognizing and understanding the intricate patterns and structures of legal texts.

The server of system 500 is polled by the client-side service until the results are ready. Once the client-side service receives the results, the user can send feedback based on the results to an internal LLM ranking system such as the one described in accordance with FIG. 4.

System 500 further comprises server-side services including an Authentication Service 512, task functions queues 518 for long running tasks such as document data extraction, and partner-specific dedicated task functions queues 520 for long running tasks such as document data extraction for a large partner. System 500 further comprises external services including system alerts platform 522, notifications service 528, and integration with a third-party legal tech platform 530.

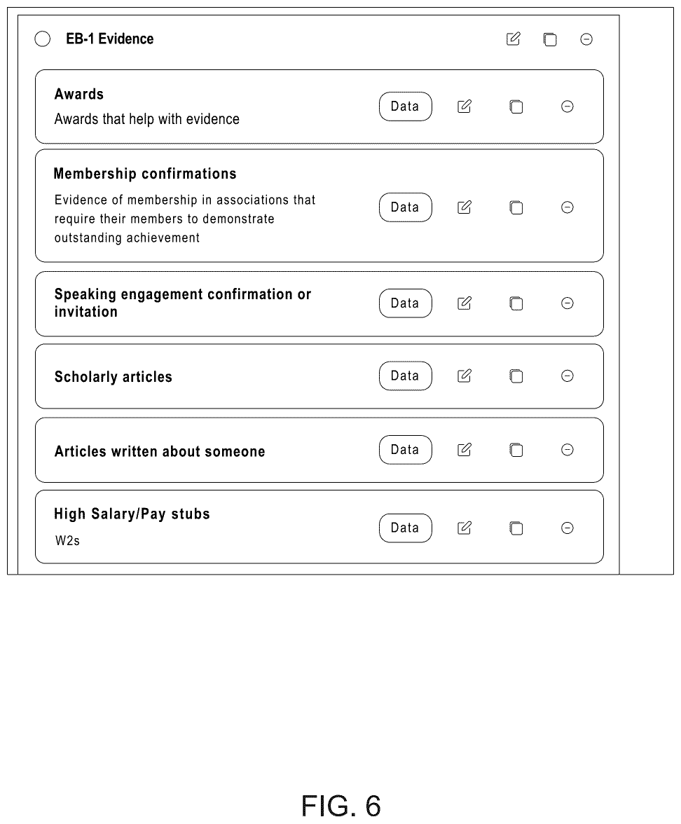

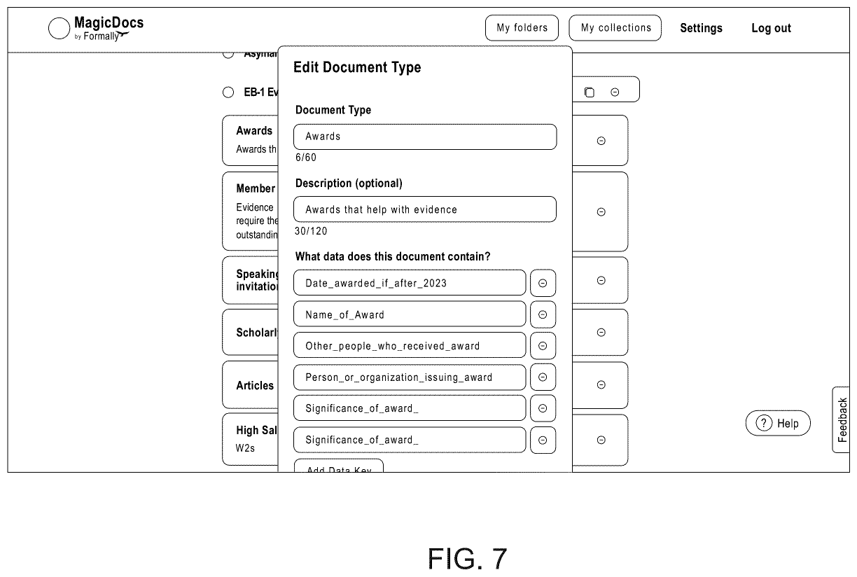

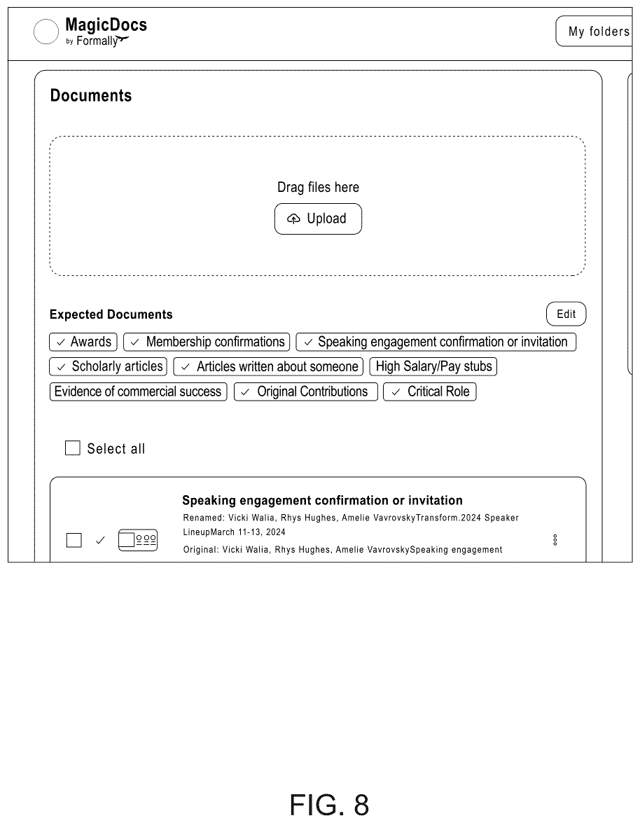

With reference to FIGS. 6-8, systems 100 and 500 are configured to allow a user to create custom collections of documents to recognize and extract data from using a user interface. In some embodiments, a user may upload awards, membership confirmations, speaking engagement confirmations or invitations, scholarly articles, articles written about someone, and W2s and other documents critical for immigration case files such as O1s and EB1s. In an embodiment, the user may edit the document type, description, and data keys to indicate the contents of the document.

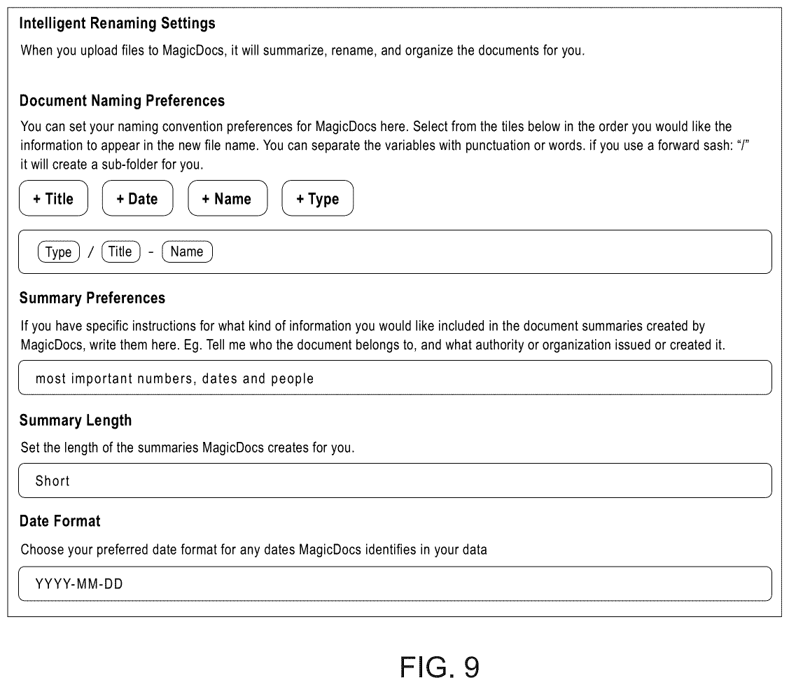

With reference to FIG. 9, systems 100 and 500 comprise user-facing settings to customize the user experience wherein uploaded documents are summarized, renamed, and organized via the intelligent renaming settings described herein. “Document Naming Preferences” comprises a text box with draggable variables as the input field. Systems 100 and 500 are configured to rename uploaded documents according to the user's preferred naming conventions. For example, a document may be named Year-Title-Name, or YYYY-TitleName. “Summary Preferences” comprises a text box which displays most important numbers, dates, and people as the input field. This field may be configured to focus on specific aspects such as numbers or specific events or facts. The user can utilize the “Summary Length” field to set their preferred summary length. The input for this field is short (e.g., a 2-3 sentence summary), medium (e.g., a 5-6 sentence summary), or long (e.g., a 2-3 paragraph summary). The “Date Format” field comprises a text box which users can utilize to select their preferred date format for any dates extracted from the document (e.g., YYYY-MM-DD or MM/DD/YYYY).

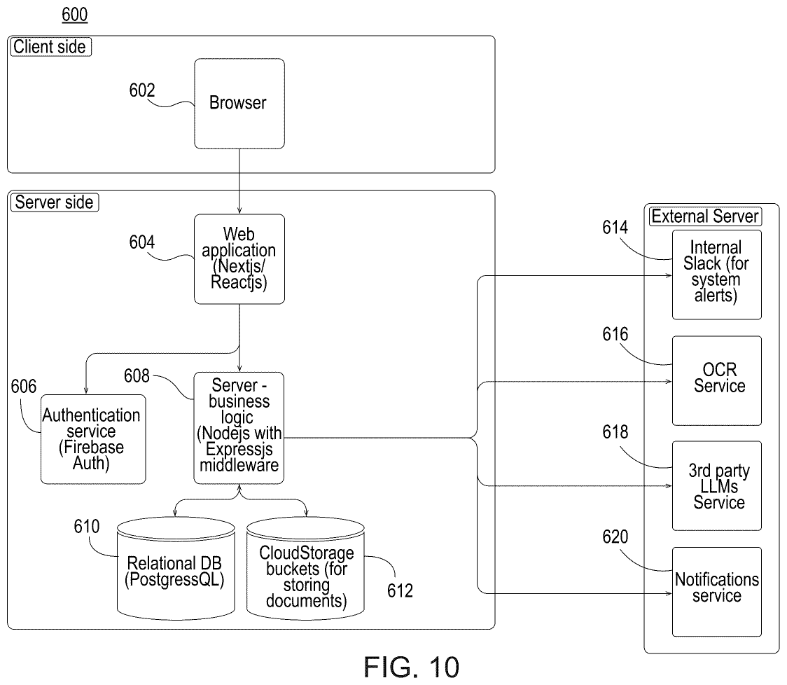

With reference to FIG. 10, a processing system 600 is disclosed in accordance with embodiments of the invention that allows the user to upload mail for extracting and cross-referencing legal data therein. System 600 comprises a web application 604 which utilizes OCR technology in conjunction with LLMs which have been trained with a focus on legal documents and terminologies in a given field, e.g., immigration law. In some embodiments, system 600 is tailored for immigration applications using editable criteria built into the LLM training process.

Web application 604 is accessible via browser 602 in response to a user request. System 600 receives uploads of mail or emails related to a given legal usage from a user. The request and uploaded documents are stored in a relational database 610 and CloudStorage buckets 612. In an embodiment, the request is initiated directly by server 608.

An OCR Service 616 accurately scans and transforms text-based data from the uploaded documents into machine-encoded digital text. OCR Service 616 is calibrated to accurately recognize a wide array of diverse fonts and handwriting styles, which are often not standardized in immigration paperwork. OCR Service 616 recognizes the characters and words in physical or digital documents, essentially turning an image of text into actual text that can be manipulated and processed by a computer.

Once the physical text has been digitized, an LLMs Service 618 interprets, categorizes, and cross-references the OCR-generated data. Based on a training set, the LLMs of LLMs Service 618 creates a processed document explaining what the uploaded documents are and how they relates to the given legal usage. In some embodiments, LLMs Service 618 is configured to identify the type of document, e.g., passport, birth certificate, driver's license, etc., identify which of the scanned in text belongs to which type or field of data based on the system's curated document types, identify a name for the document, and return to the user a set of structured, properly extracted and formatted documents which the user can then use for some legal purpose, e.g., to apply for a VISA or citizenship. In an embodiment, the LLMs of LLMs Service 618 have been specifically trained on legal documents and terminologies, for example, a training set comprising immigration documents, making them particularly effective at recognizing and understanding the intricate patterns and structures of legal texts.

System 600 further comprises server-side services including an Authentication Service 606 and external services including system alerts platform 614 and notifications service 620.

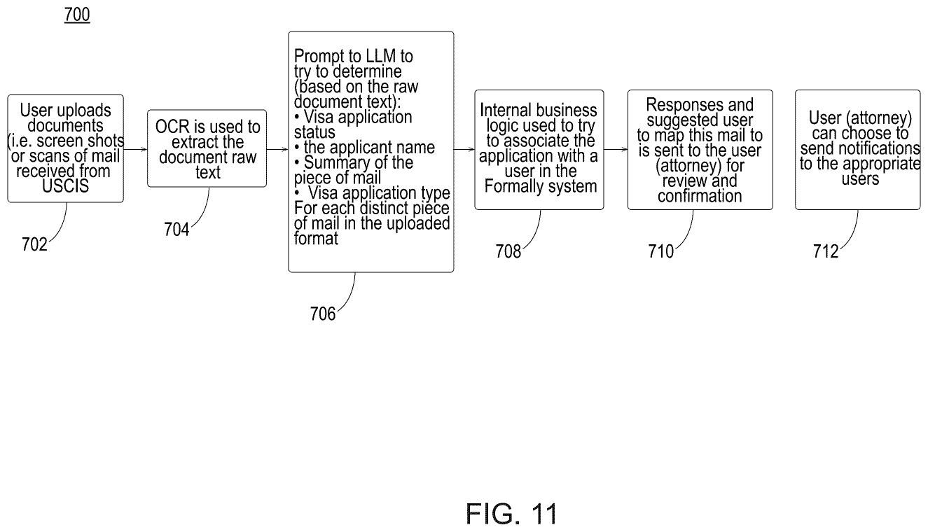

With reference to FIG. 11, a process 700 of using system 600 to upload mail for extracting and cross-referencing legal data therein in accordance with some embodiments will now be described. The process of FIG. 11 comprises steps 702 through 712 and is suitable for use in system 600 but is more generally applicable to other types of systems for data processing using artificial intelligence.

At step 702, mail or emails related to a given legal usage (e.g., screenshots or scans of mail received from United States Citizenship and Immigration Services (“USCIS”)) are introduced into system 600 via user upload. At step 704, OCR is used to extract raw text from the uploaded documents.

At step 706, a microprompt is sent to trained LLMs to determine, based on the raw document text, VISA application status, applicant name, a summary of the piece of mail, and VISA application type for each distinct piece of mail in the uploaded documents. At step 708, internal business logic is used to associate the applicant with a user in system 600. At step 710, responses from the LLMs, as well as the suggested user to map this mail to, are sent to the user for review and confirmation. In an embodiment, the user is an attorney preparing an immigration portfolio for a client. At step 712, the user may choose to send notifications of the results of process 700 to the appropriate users.

In some embodiments, system 600 automatically scans every piece of mail received, including notices from USCIS. Once a relevant document is scanned, system 600 sends automated notifications to the appropriate users, ensuring they are informed in real-time. In some embodiments, system 600 utilizes data encryption measures to ensure all scanned documents are kept confidential.

The particular processing operations and other system functionality described in conjunction with the flow diagrams of FIGS. 2 through 4 and FIG. 11 are presented by way of illustrative example only and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement the disclosed embodiments.

Functionality such as that described in conjunction with the processes of FIGS. 2-4 may be implemented at least in part in the form of one or more software programs stored in memory and executed by a processor of a processing device such as a computer or server. As will be described herein, a memory or other storage device having executable program code of one or more software programs embodied therein is an example of what is more generally referred to herein as a “processor-readable storage medium.”

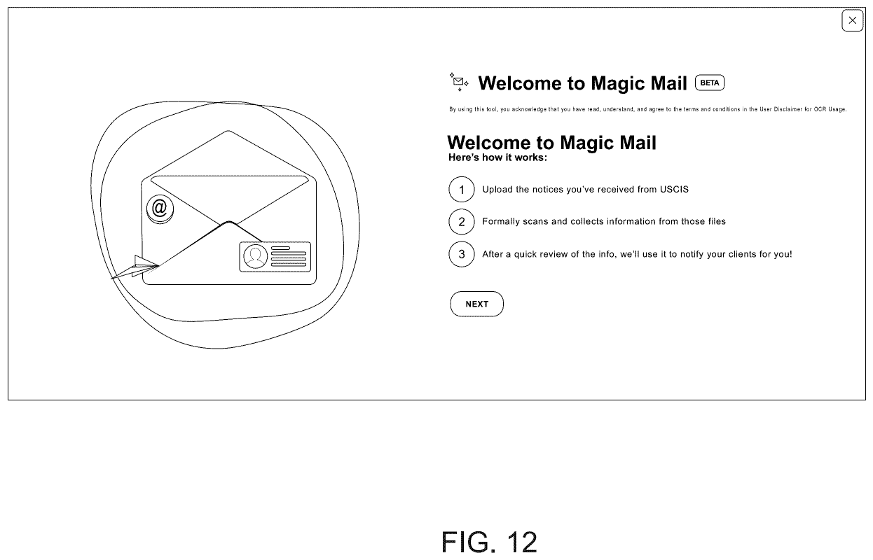

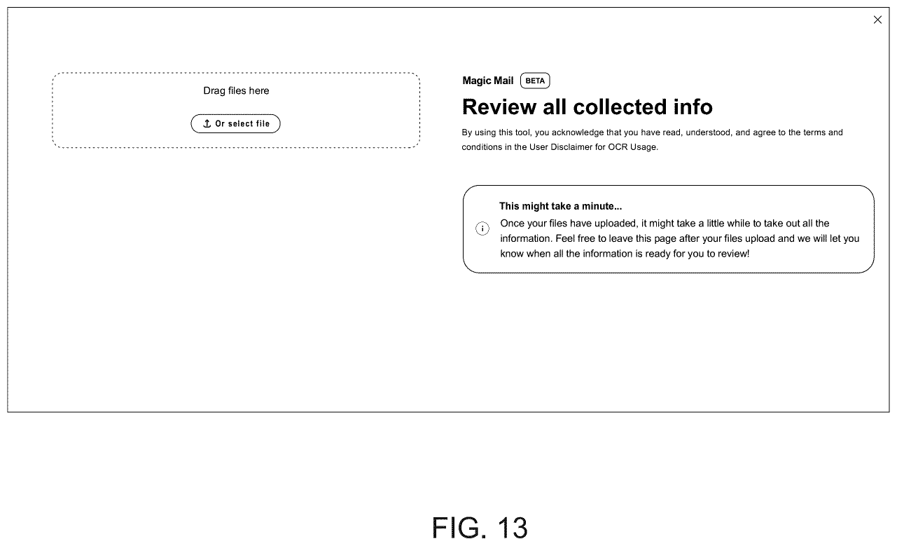

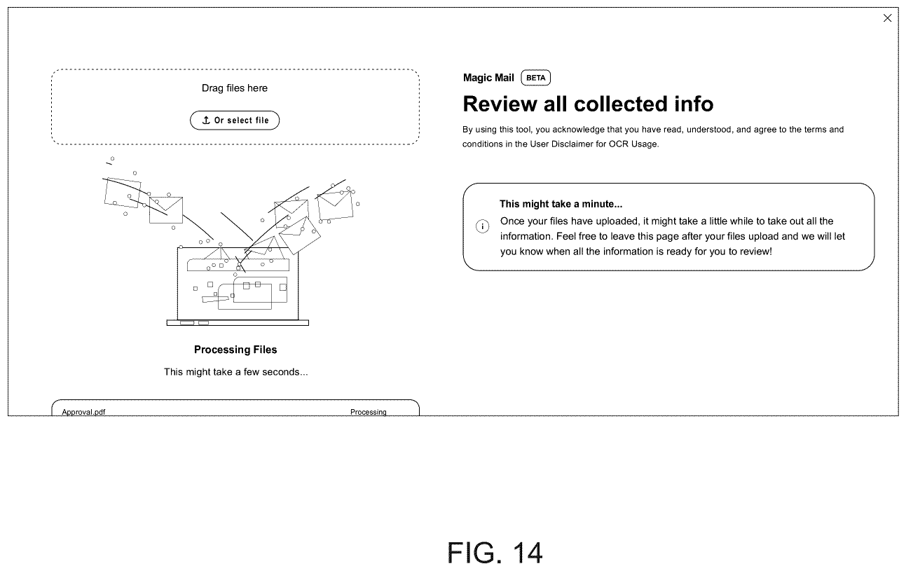

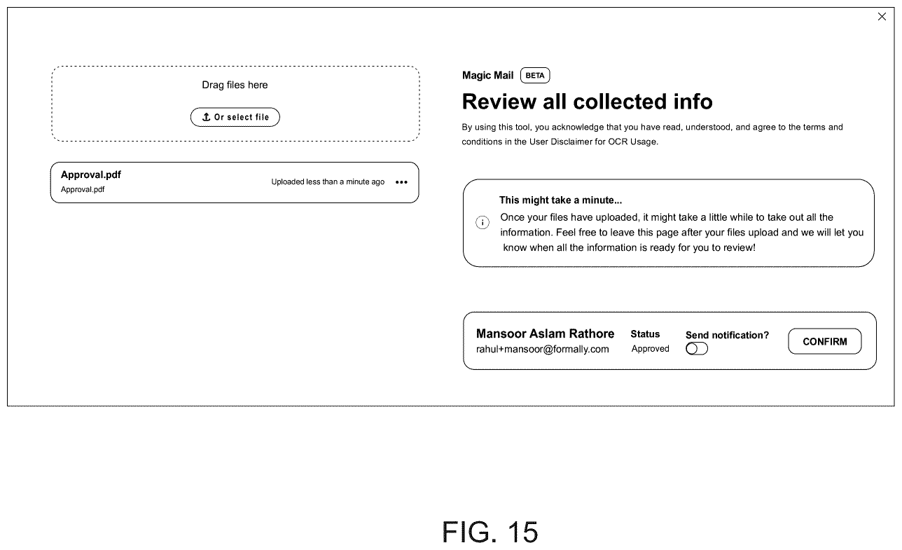

With reference to FIGS. 12-15, a user interface for system 600 is shown in accordance with an embodiment. The user may drag and drop documents or select a file for review. In some embodiments, system 600 comprises customizable notification templates as well as mobile access.

FIGS. 1 through 15 are conceptual illustrations allowing for an explanation of the disclosed embodiments of the invention. Notably, the figures and examples above are not meant to limit the scope of the invention to a single embodiment, as other embodiments are possible by way of interchange of some or all of the described or illustrated elements. Moreover, where certain elements of the disclosed embodiments can be partially or fully implemented using known components, only those portions of such known components that are necessary for an understanding of the disclosed embodiments are described, and detailed descriptions of other portions of such known components are omitted so as not to obscure the disclosed embodiments. In the present specification, an embodiment showing a singular component should not necessarily be limited to other embodiments including a plurality of the same component, and vice-versa, unless explicitly stated otherwise herein. Moreover, terms in the specification or claims are not intended to be ascribed an uncommon or special meaning unless explicitly set forth as such. Further, the disclosed embodiments encompass present and future known equivalents to the known components referred to herein by way of illustration.

It should be understood that the various aspects of the embodiments could be implemented in hardware, firmware, software, or combinations thereof. In such embodiments, the various components and/or steps would be implemented in hardware, firmware, and/or software to perform the functions of the disclosed embodiments. That is, the same piece or different pieces of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description will so fully reveal the general nature of the disclosed embodiments that others can, by applying knowledge within the skill of the relevant art(s) (including the contents of the documents cited and incorporated by reference herein), readily modify and/or adapt for various applications such specific embodiments, without undue experimentation, without departing from the general concept of the disclosed embodiments. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A method using artificial intelligence for converting a set of legal documents of varied type related to a legal task into structured data suitable for the legal task, the method performed by at least one processor comprising hardware, the method comprising:
receiving from a user digitized versions of a plurality of legal documents;
extracting electronic data from the digitized legal documents using optical character recognition (OCR);
analyzing the extracted electronic data from each document using a sequence of microprompts to a trained large language model (LLM), the analyzing comprising:
using the LLM to identify a type of the document from which the electronic data was extracted;
using the LLM to identify data keys within the electronic data based on the identified document type and a set of curated data key templates for such document type, and to assign portions of the electronic data to the data keys identified for each such portion; and
using the LLM to generate a name for the document;
and
storing and sending to the user the analyzed electronic data processed with the LLM as structured data suitable for the legal task.

2. The method of claim 1, wherein the legal documents include one or more documents with handwritten text, and wherein the step of extracting data using OCR comprises calibrating the OCR to recognize handwritten text.

3. The method of claim 1, wherein the legal documents include one or more documents with diverse font styles and sizes, and wherein the step of extracting data using OCR comprises using an OCR calibrated to recognize font of diverse styles and sizes.

4. The method of claim 3, wherein the legal documents relate to immigration and wherein using the OCR comprises using OCR calibrated to recognize font of diverse styles and sizes typically used in immigration documents.

5. The method of claim 1, wherein the legal documents relate to immigration and wherein analyzing the extracted data using the LLM comprises using an LLM which has been trained on immigration terminologies and document formats.

6. The method of claim 5, wherein using an LLM comprises using an LLM which has been trained on evidence required in immigration cases to thereby identify document types and data keys based on an identification of such evidence in the extracted electronic data.

7. The method of claim 1, comprising allowing the user to modify the sequence of LLM microprompts.

8. The method of claim 1, wherein analyzing the extracted electronic data from each document comprises analyzing the extracted electronic data by a plurality of LLMs.

9. The method of claim 8, wherein analyzing the extracted electronic data by a plurality of LLMs comprises sending the extracted data to the plurality of LLMs in parallel.

10. The method of claim 8, comprising ranking the structured data produced by the plurality of LLMs based on a ranking system and identifying a top ranked set of structured data to send to the user.

11. A system using artificial intelligence for converting a set of legal documents of varied type related to a legal task into structured data suitable for the legal task, the system comprising:
a web application configured to receive from a user digitized versions of a plurality of legal documents;
a database for storing the received digitized legal documents;
a task function queue for coordinating the processing of the digitized legal documents into structured data, the task function queue configured to:
transmit the digitized legal documents to an optical character recognition (OCR) system to extract electronic data from the digitized legal documents;
transmit the extracted electronic data from each document to a trained large language model (LLM) using a sequence of microprompts to analyze the extracted electronic data to (i) identify a type of the document from which the electronic data was extracted, (ii) identify data keys within the electronic data based on the identified document type and a set of curated data key templates for such document type, (iii) assign portions of the electronic data to the data keys identified for each such portion and (iv) generate a name for the document; and
receive, store and send to the user the analyzed electronic data processed with the LLM as the structured data suitable for the legal task.

12. The system of claim 11, wherein the legal documents include one or more documents with handwritten text, and wherein transmitting the digitized legal documents to an OCR system comprises transmitting the digitized legal documents to an OCR calibrated to recognize handwritten text.

13. The system of claim 11, wherein the legal documents relate to immigration and wherein transmitting the digitized legal documents to an OCR system comprises transmitting the digitized legal documents to an OCR calibrated to recognize font of diverse styles and sizes typically used in immigration documents.

14. The system of claim 11, wherein the legal documents relate to immigration and wherein transmitting the extracted electronic data from each document to a trained LLM comprises using an LLM which has been trained on immigration terminologies and document formats.

15. The system of claim 14, wherein transmitting the extracted electronic data from each document to a trained LLM comprises using an LLM which has been trained on evidence required in immigration cases to thereby identify document types and data keys based on an identification of such evidence in the extracted electronic data.

16. The system of claim 11, comprising the task function queue allowing the user to modify the sequence of LLM microprompts.

17. The system of claim 11, wherein transmitting the extracted electronic data from each document to a trained LLM comprises transmitting the extracted electronic data to a plurality of LLMs.

18. The system of claim 17, wherein transmitting the extracted electronic data to a plurality of LLMs comprises transmitting the extracted data to the plurality of LLMs in parallel.

19. The method of claim 18, wherein the system is configured to rank the structured data produced by the plurality of LLMs based on a ranking system and identify a top ranked set of structured data to send to the user.

20. Non-transitory computer-readable media comprising program code that when executed by a programmable processor causes execution of a method using artificial intelligence for converting a set of legal documents of varied type related to a legal task into structured data suitable for the legal task, the computer readable media comprising:
computer program code for receiving from a user digitized versions of a plurality of legal documents;
computer program code for extracting electronic data from the digitized legal documents using optical character recognition (OCR);
computer program code for analyzing the extracted electronic data from each document using a sequence of microprompts to a trained large language model (LLM), the analyzing comprising:
using the LLM to identify a type of the document from which the electronic data was extracted;
using the LLM to identify data keys within the electronic data based on the identified document type and a set of curated data key templates for such document type, and to assign portions of the electronic data to the data keys identified for each such portion; and
using the LLM to generate a name for the document;
and
computer program code for storing and sending to the user the analyzed electronic data processed with the LLM as structured data suitable for the legal task.
